(19) United States
(12) Patent Application Publication
(10) Pub. No.: US 2005/0050556 A1
(43) Pub. Date: Mar. 3, 2005

(54) Dynamic layout method for an application program module

(75) Inventors: Yu-hyok Kim, Seongnam-si (KR); Deok-ho Kim, Seoul (KR); Chang-ki Choi, Anyang-si (KR); Jeong-yeon Moon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/929,690

(22) Filed: Aug. 31, 2004

(30) Foreign Application Priority Data
Sep. 2, 2003 (KR) 10-2003-0061242

(51) Int. Cl. G06F 9/46

(52) U.S. Cl. 719/328

(57) ABSTRACT

A dynamic layout method of an application program module, comprising steps of loading a plurality of program modules operating independently; generating a common information storage to establish data communication among the program modules; allowing a first module receiving instructions by a user, among the program modules, to record data to perform the instructions on the common information storage; and allowing a second module capable of performing the instructions among the program modules, to read out the data from the common information storage and to perform the instructions using the data.

### CROSS-REFERENCE TO RELATED APPLICATION

This application claims priority of Korean Patent Application No. 10-2003-0061242 filed Sep. 2, 2003 in the Korean Intellectual Property Office, the content of which is hereby incorporated herein by reference.

### BACKGROUND OF THE INVENTION

1. Field of the Invention

The present invention relates to a dynamic layout method for application program modules and, more particularly, to a method for facilitating any change in configuration of a user interface or a program skin image without recompiling a source code, by assigning the configuration of the user interface or the program skin image to a separate document other than a document which includes a source code.

2. Description of the Related Art

An operating system (hereinafter referred to as “OS”) provides application program interfaces (hereinafter referred to as “APIs”) capable of controlling all units identified by the OS, excluding some units used for special purposes to develop programs in its own environment. API's vary in kind, and they include a basic file I/O API to manage files, an API to control media files, an API to make it possible to communicate with external units using communication protocols, etc. A developer developing an application program on the basis of a specified OS completes the program as desired, using characteristics of various APIs provided by the OS and a rule involved in a method for the OS to identify and control a program.

The developer developing a User Interface (hereinafter referred to as “UI”) application program based on an Object Oriented Program on the OS designs a variety of functions in the unit of modules, each of which have an independent unit function, and designs and develops a single UI application program by making a combination of a method for transferring commands and data between modules, a method for displaying something on a screen by the corresponding OS, a method for converting such information and a method for defining what response is to be shown when any instruction is received.

For example, a window OS provides various controls, which are used in its own OS, capable of constructing a basic program, and various interfaces such as a graphical display interface (GDI) that displays figures on the screen using special colors and methods. Also, a method for transferring instructions between controls, such as a message handling scheme is provided.

Hereinafter, lots of information used when the UI application program is made will be called resources. The information may include a coordinate and position of a button when a control such as a button is viewed on the screen, or the layout method such as a rearrangement form of the button, and when the button is constructed with a specified image, the information on the image also becomes a part of the resources.

When a program is designed in a conventional art, coding is directly made in a source program using the information described above. Of course, even though some information is exposed externally from the source program, much of the information is made constant as a part of code, or recorded in a header file. Functions having logic involved in a method to arrange layouts of controls viewed on the screen using values comprising the above-described information, are constructed, and interfaces among a plurality of modules are constructed. In case of such an application program, the user has no other choice but to use a form of layout and UI configuration provided by a program vendor. Accordingly, when there has occurred a need to apply a new specification without modifying an existing construction, in order to modify the concerned portion, it is necessary to review and modify all portions which are relevant or may be relevant to the portion concerned within the program, and the whole program should be recompiled after finishing all the processes.

When coding a program, in order to perform a specific function which is unable to be executed by the program itself, it is needed to use the API provided by the OS or a member function of a concerned instance by generating the instance of a class capable of performing the function. However, this method is limited in that the coding and compiling when coding a program can only be done under the condition that a name of the corresponding API or the class is known. For this reason, it has been possible to proceed with a project only when a list of all functions and information on where each function is to be obtained were determined before the compiling. Accordingly, this method is disadvantageous since, when a variety of functions are required and they are highly likely to be modified, modification of the corresponding portion and recompiling of the whole project must be done in order to add/delete/change a function.

Even though an API of WINDOWS may produce a program without knowing its name before compiling it by using a special method, it cannot be a useful solution when the method is so complicated and the functions are diverse. Also, when a class name is not known, it is not possible to do compiling itself since there is no way to generate an instance of the corresponding class.

In programs that directly process files, like a word processor and a media player among UI applications having a complicated UI configuration, user's requests are various and input and output methods thereof vary accordingly.

There are various input and output scenarios according to cases; that is, when, a computer identifies a certain device, a special file is executed in a form of “double click” or “enter”, and a program operating in “A” mode is converted to be operated in “B” mode.

At this time, the UI configuration that can be represented is also various. An existing program was developed adaptively only to the specific function as required. In accordance with various input and output configurations, information and operations necessary in an initial step of the corresponding module are changed, added, deleted, or modified in the middle or end stages of the project, and the program has to be modified whenever there occurs such a change. In this regard, there occur various problems that have not been foreseen, and these problems have been solved with bugs or elimination of concerned functions.

Accordingly, when the UI or a Graphic User Interface (hereinafter referred to as ‘GUI’) is changed, source codes of the corresponding part are to be changed and recompiled, which is inconvenient. However, the UI or GUI can conveniently be changed by introducing a new software architecture.

### SUMMARY OF THE INVENTION

The present invention has been conceived to solve the problems described above. It is an object of the present invention to provide a method for changing an UI or GUI by dividing an application program into a plurality of layers and modifying only an XML document that is used generally and can be modified conveniently without recompiling the application program.

To achieve the object, the present invention provides a dynamic layout method for an application program module, comprising the steps of loading a plurality of program modules operating independently, generating a common information storage to make data communication among the program modules, allowing a first module receiving instructions by a user, among the program modules, to record data to perform the instructions on the common information storage, and allowing a second module capable of performing the instructions among the program modules, to read out the data from the common information storage and to perform the instructions using the data. Preferably, the configuration of each of the program modules is defined as XML documents. At this time, the program modules include component modules which can make an I/O communication with the user using a user interface, container modules including a plurality of component modules, and engine modules which do not include the user interface and which process a user's request internally.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a view showing the basic construction of an XML document that each program module has in accordance with an exemplary embodiment of the present invention.

FIG. 2 is a view showing an application program in accordance with an exemplary embodiment of the present invention.

FIG. 3 is a view showing an XML document for explaining a construction of the application program shown in FIG. 2.

FIG. 4 is a view showing an XML document for explaining a construction of an arbitrary module included in the application program shown in FIG. 2.

FIG. 5 is a flow chart illustrating how to load one module from an application program in accordance with an exemplary embodiment of the present invention.

FIG. 6 is a view showing a method for sharing data among modules in accordance with an exemplary embodiment of the present invention.

### DETAILED DESCRIPTION OF THE INVENTION

Hereinafter, a dynamic layout method for an application program module according to the present invention will be described in detail with reference to the accompanying drawings.

The present invention proposes a new form of application program architecture. In this regard, terms used in the present invention will be defined before explaining an embodiment of the present invention for the sake of understanding.

1. Component

A component is a constituent of an UI, which is able to communicate with a user, by receiving input from the user, or displaying the user results processed in response to the user's request.

2. Container

A container refers to a set of components that have the same attribute among various components. For example, assuming that there are 3 components, namely, ‘title display line’, ‘menu bar’ and ‘main display’, 4 components of system button, minimization button, maximization button and end button may be positioned under the ‘title display line’. In this respect, the ‘title display line’ can be a container containing 4 components, and can also be a component of an application program container. That is, the container may be a component of another container, and may include another component.

3. Engine

The UI part of the application program can be explained using the container and component. However, a unit which fulfils an actual function is needed, in addition to the UI, in order to operate the application program. That is, the unit is a part which each component has to process according to the user's request, which does not require the UI part. The unit responsible for this function is referred as an engine in the present invention.

The engine cannot recognize when a user makes a request with respect to the application program. Receiving a result from the component's analysis of the user's request, the engine performs tasks which can be done by it, and returns the result back to the component. The engine is concealed in the application program.

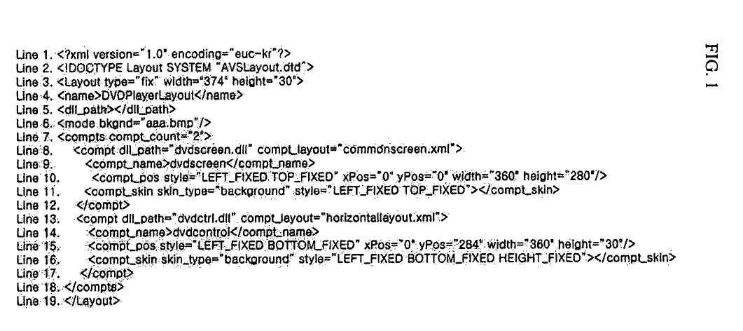

FIG. 1 is a view showing the basic construction of an XML document that each program module has in accordance with an exemplary embodiment of the present invention.

Schematic construction, element and properties of the XML document will be explained with reference to line numbers shown in FIG. 1.

Lines 1 and 2 correspond to a header part of the XML document.

‘Layout’ element in line 3 has a ‘type’, ‘width’ and ‘height’ as property.

The ‘type’ is a style of layout resizing mode, where ‘fix’, ‘resize’ and ‘flex’ are possible modes.

The ‘fix’ mode means that the layout is not changed but fixed and that its construction is not changed in size and position. The ‘resize’ mode means that the layout is freely changed and that the user can change its size and support the resizing. The ‘flex’ mode means that the layout is determined by a position calculation algorithm. For example, when there are 5 components in a container, the 5 components are arranged by calculation, such as uniformly in a vertical or circle shape. This construction is not calculated directly even though a function is added, and the program automatically calculates and displays the position.

The ‘width’ indicates a basic width of the layout, and the ‘height’ indicates a basic height of the layout.

‘name’ in line 4 indicates a name of a ‘Layout’ element.

‘dll_path’ in line 5 indicates a dll path having an algorithm function that calculates a position of each module when the ‘type’ of the ‘Layout’ element is the ‘flex’.

‘bkgnd’ of a ‘mode’ element in line 6 indicates a background image of the entire module.

‘compts’ element in line 7 indicates a set of components included in a corresponding module, and ‘compt_count’ indicates the number of components which are included in the corresponding module.

‘compt dll_path’ in line 8 indicates a path of the component, and ‘comptlayout’ indicates a layout document name of the component.

‘compt_name’ in line 9 indicates a name of the component. The name of the component should be unique in a document.

‘compt_pos’ in line 10 indicates a position of the component, and includes properties such as ‘style’ indicating a resizing style, ‘xPos’ indicating an X coordinate, ‘yPos’ indicating a Y coordinate, ‘width’ indicating a width, and ‘height’ indicating a height.

‘compt_skin’ in line 11 indicates a skin of the component, and includes a property such as ‘skin ype’ indicating a type of the component which expresses the skin, such as button, list, and background. There is a relative path of a skin image between ‘<comp_skin>’ and ‘</comp_skin>’.

The skin type of the component will be further described with reference to [Table 1].

TABLE 1
The skin type of the component and the number of images needed

| | | The number of images |
|---|---|---|
| Skin type | Description | needed |
| BACKGROUND | Skin inputted into the | According to resizing |
| | background of container | mode, |
| | | 1. ‘WIDTH_FIXED’, |
| | | ‘HEIGHT_FIXED’ |
| | | 2. ‘WIDTH_FIXED’ |
| | | 3. ‘HEIGHT_FIXED’ |
| | | Each resizing information is |
| | | adopted as defined in |
| | | components. |
| BUTTON | Left of object is changed | One (images having |
| | proportionally. | Default, Hover, Pressed, |
| | | Disabled in its tail) |
| TREE | Treecontrol | Two (Image List, |
| | | Background) |
| LIST | Listcontrol | Two (Image List, |
| | | Background) |
| SCROLL | Scrollbar | Two (Scrollbar, |
| | | Background) |
| COMBO | Combobox | Two (Dropdown Button, |
| | | Background) |
| SLIDER | Slidebar | One |
| USERDEFINE | Structure which is used | It depends on an image |
| | only in a special | form, and a resizing mode. |
| | component for special | |
| | purpose, among skin | |
| | information inputted into | |
| | component | |

The skin structure is roughly classified into two types. One is a component having a background, and the other is a component having no background.

For example, while the listcontrol and the treecontrol have the background, the button has no background.

The skin needs a number of images. Since different images are needed in each state, when one button, one scrollbar or one background is expressed, the number of images may be 1 (the minimum) to 10 (the maximum). Since it is difficult to express all images between ‘<compt_skin>’ and ‘</compt_skin>’, all images are expressed using 2 images in the present invention.

First of all, the 2 images used are composed of an image indicating the background of each module and an image of the module itself. In case several pieces of images are needed for the image of the module itself, each image is gathered in one image file and each image is divided and used on the program.

For example, 4 images are generally needed to cover a button with an image, that is, a basic image, an image when a mouse is on the button, an image when the button is pressed, and an image in a ‘disable’ state. Respective images are connected in a file in a certain order (for example, Default-Hover-Select-Disable) so as to make an image file, and one of the 4 images is expressed by writing a code for dividing the image file in a source code which expresses the button.

By doing so, it is possible to express one button with one image.

Likewise, even though a module needs various kinds of images, since a single image file is sectioned into a plurality of maps and each image is arranged in the module according to the maps, and the image is then extracted from the code, it is possible to use the module with one image file. While 2 images are used in the present invention, it is possible to compose a module with only one image file.

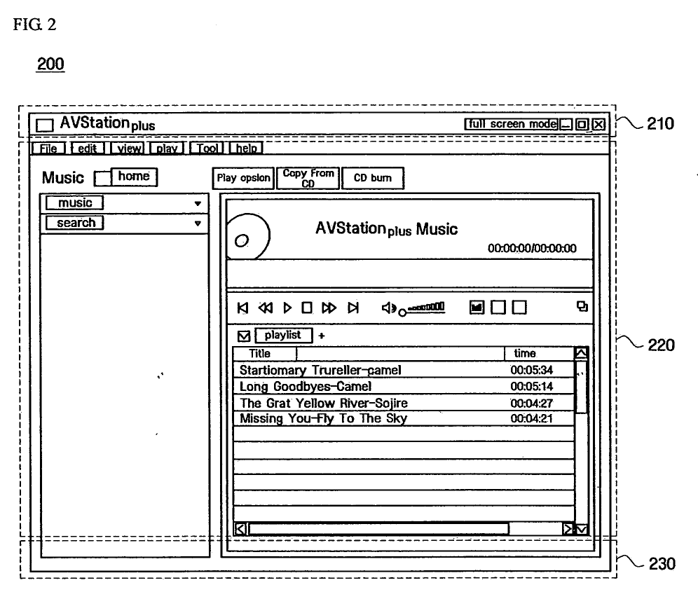

FIG. 2 is a view showing an application program in accordance with an embodiment of the present invention.

The application program is constructed with total 3 sub-modules 210, 220 and 230.

This construction is defined in a separate XML document in which modes according to various situations are included. Modes matched to respective situations are loaded from the application program.

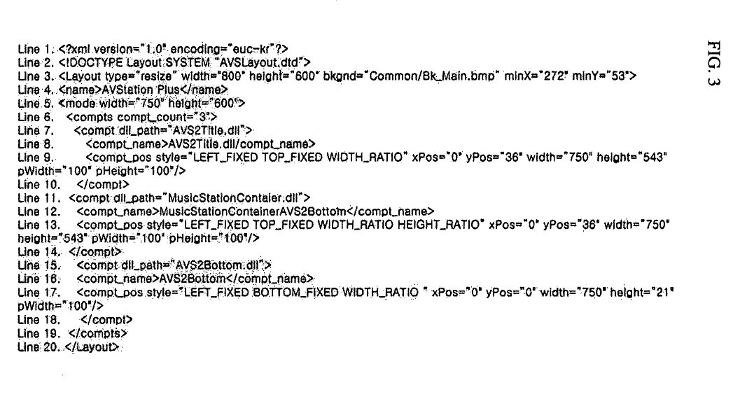

FIG. 3 is a view showing an XML document for explaining a construction of the application program shown in FIG. 2, which construction is made of a layout component for allowing a user to listen to the music.

Line 6 shows that the application program shown in FIG. 2 has total 3 components.

Lines 7 to 10 explain a component 210, lines 11 to 14 a component 220, and lines 15 to 18 a component 230.

That is, there are roughly 3 kinds of sub-modules in the application program shown in FIG. 2, which are defined in AVS2Title.dll, MusicStationContainer.dll, and AVS2Bottom.dll. The application program can know through the XML document which module is to be loaded as a sub-module according to a mode.

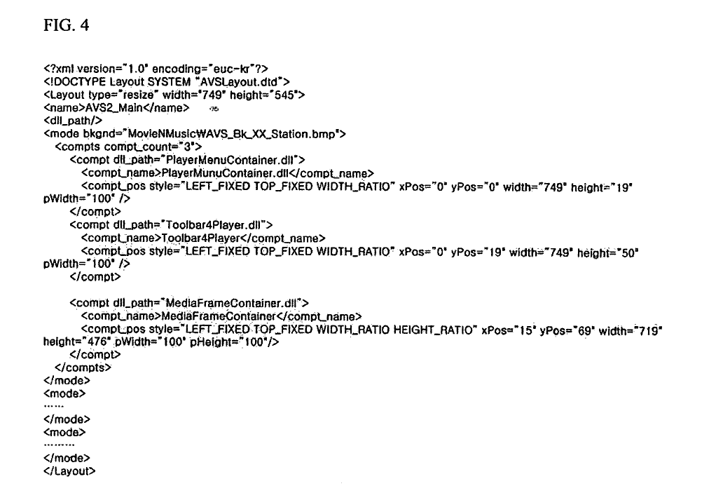

The MusicStationContainer.dll corresponding to the component 220 provides explanation for construction of the component 220, which is shown in FIG. 4. Referring to FIG. 4, there are 3 kinds of modules named ‘PlayerMenuContainer’, ‘Toolbar4Player’, and ‘MediaFrameContainer’. That is, the module whose name is ‘MusicStationContainer.dll’ shown in FIG. 3 is also regarded as a container having 3 components. Also, referring to FIG. 4, there are 3 modes of ‘Default’, ‘Simple’ and ‘Remocon’ and their definitions are in the MusicStationContainer.

As illustrated in FIGS. 2 to 4, the configuration of the application program can be modified depending upon what information is described in the XML document which shows the configuration of the program module.

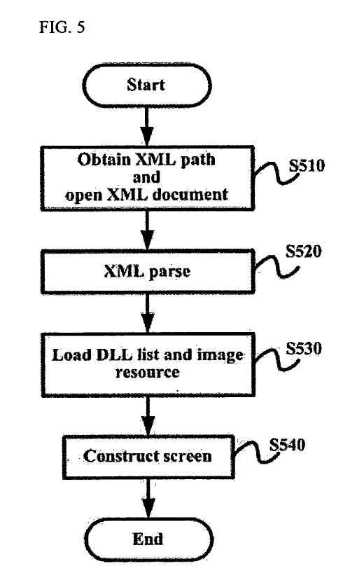

FIG. 5 is a flow chart illustrating how to load one module from an application program in accordance with an exemplary embodiment of the present invention.

When the application program starts to operate, a path on which an XML document describing the configuration of the application program is positioned is obtained and the XML document placed on the path is opened (S510). Then, necessary information is extracted by parsing the XML document (S520), and a corresponding DLL list and image resources are loaded using the information (S530). Finally, a screen is constructed by executing the module described in the DLL list and fetching a necessary image (S540).

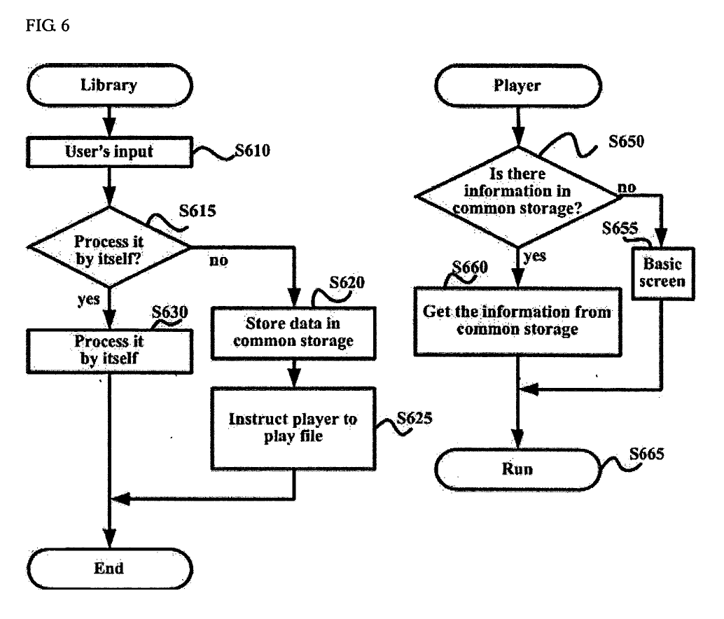

FIG. 6 is a view showing a method for sharing data among modules in accordance with an exemplary embodiment of the present invention.

Data sharing is an aspect of the present invention because it is necessary to transfer a task which a module cannot process to another module which can process the task. In the architecture of the application program in accordance with the present invention, each module cannot recognize existence of other modules than itself since they exist independently. The independency of each module constitutes one of the features of the present invention. Accordingly, a module is in need of informing another module of a task which cannot be processed by itself so that the task can be processed by the latter module. Also, since each module cannot recognize whether other modules than itself are loaded on a memory, it cannot use an existing method to call functions. For this reason, the present invention employs a method in which a specified space is assigned in a data sharing storage such as a memory or file, necessary information is stored therein, and the information is retained even though the information is unloaded from the memory, so that another module can process the task in reference to the information retained.

For example, assuming that there is a program managing a media program (hereinafter referred to as a ‘library’) and a program playing the media file (hereinafter referred to as a ‘player’), the library and player exist as independent modules in the present invention, and thus, they do not recognize each other's existence. When a file is selected in the library (S610), the selected file should be played. However, playing of the file is beyond functions of the library. Since the file cannot be played in the library, the library has to transfer information to another module to play this file. At this time, since the player has not yet been loaded on the memory, the library cannot transfer the information directly to the player, and thus, the information on the file to be played is recorded on the common storage (S615 and S620). And, an instruction to play the file is transferred to the player (S625). The instruction to play the file is an instruction itself and does not include information on the file. Receiving instruction to play the file, the player retrieves information from the common storage (S650). At this time, if the information exists, the information is read and played (S660). And, if the information does not exist, a basic screen will be shown (S655).

Although the preferred embodiments and drawings of the present invention have been disclosed for illustrative purposes, those skilled in the art appreciate that various substitutions, modifications, changes and additions are possible, without departing from the scope and spirit of the invention as disclosed in the accompanying claims.

According to the present invention described above, it is possible to develop application programs efficiently in which function or UI modification of the program can occur frequently, new functions can be added and deleted with ease, and a skin can be changed outside the application program such as a modification of an XML document, and an effect can be obtained that a user can make use of various skins conveniently.

1. A dynamic layout method for an application program module, comprising:
loading a plurality of program modules operating independently;
generating a common information storage to establish data communications among the plurality of program modules;
receiving, by a first module among the plurality of modules, instructions from a user to record data to perform instructions on the common information storage; and
performing the instructions, by a second module among the plurality of program modules, to read out the data from the common information storage, and performing the instructions using the data.

2. The method according to claim 1, wherein a configuration of each of the plurality of program modules is defined as a respective XML document.

3. The method according to claim 2, wherein the plurality of program modules comprise component modules which are operable to establish I/O communication with the user using a user interface, container modules comprising a plurality of component modules, and engine modules which do not include the user interface and process a user's request internally.

4. The method according to claim 1, further comprising:
determining whether said first module will perform said instructions; and
if said first module will not perform said instructions, said data to perform said instructions is recorded on the common information storage.

5. The method according to claim 4, further comprising, informing said second module that said data is recorded on the common information storage.

6. The method according to claim 1, further comprising:
determining whether said data is recorded on the common information storage;
if said data is recorded on the common information storage, reading out data from said common information storage, by said second module, and performing said instructions using the data.

7. The method according to claim 1, wherein loading one of the plurality of program modules comprises:
obtaining a path on which a document describing a configuration of an application program of the plurality of program modules, is provided;
opening a document on said path;
extracting the document;
loading a corresponding dynamic link library (DLL) list and image resources; and
constructing a screen.

8. The method according to claim 7, wherein said document is an extensible markup language (XML) document.
